(19) United States
(12) Patent Application Publication
(10) Pub. No.: US 2006/0013144 A1
(43) Pub. Date: Jan. 19, 2006

(54) Optical switch

(75) Inventor: Miguel De Vega Rodrigo, Woluwe St. Lambert (BE)

Correspondence Address: CROWELL & MORING LLP;INTELLECTUAL PROPERTY GROUP, P.O. BOX 14300, WASHINGTON, DC, 20044-4300, US

(73) Assignee: Siemens Aktiengesellschaft, Muenchen (DE)

(21) Appl. No.: 11/179,580

(22) Filed: Jul. 13, 2005

(30) Foreign Application Priority Data
Jul. 17, 2004 (GB) 0416071.9

(51) Int. Cl. H04J 3/14

(52) U.S. Cl. 370/249; 398/45

(57) ABSTRACT

An optical switch includes a controller controlling the switch such that a plurality of switching matrixes operate in parallel to switch optical data bursts across the switch.

This invention relates to an optical switch and in particular but not exclusively an optical switch for use in an optical burst switching (OBS) network.

In burst switching technology networks, such as, optical burst switching (OBS) networks, data bursts, each of which is made up of multiple packets, are switched optically at switches or routers in the OBS network. Each data burst has an associated control packet called the burst header packet. A burst header packet travels an offset time ahead of its data burst along the same route and configures the optical switches to route the data burst. Thus, each burst header packet travels an offset time ahead of its associated data burst and establishes a path for the data burst.

Each burst header packet contains the information, such as a label, the length of the burst, and the offset time, required to route the associated data burst through the optical core backbone. A burst header packet is sent via out-of-band in-fiber control channels and is processed electronically at the controller of a switch to make routing decisions, such as selection of an outgoing fibre and wavelength. The switch is configured accordingly to switch the data burst, which is expected to arrive after the designated offset time. When it arrives at the switch, the data burst is switched entirely in the optical domain.

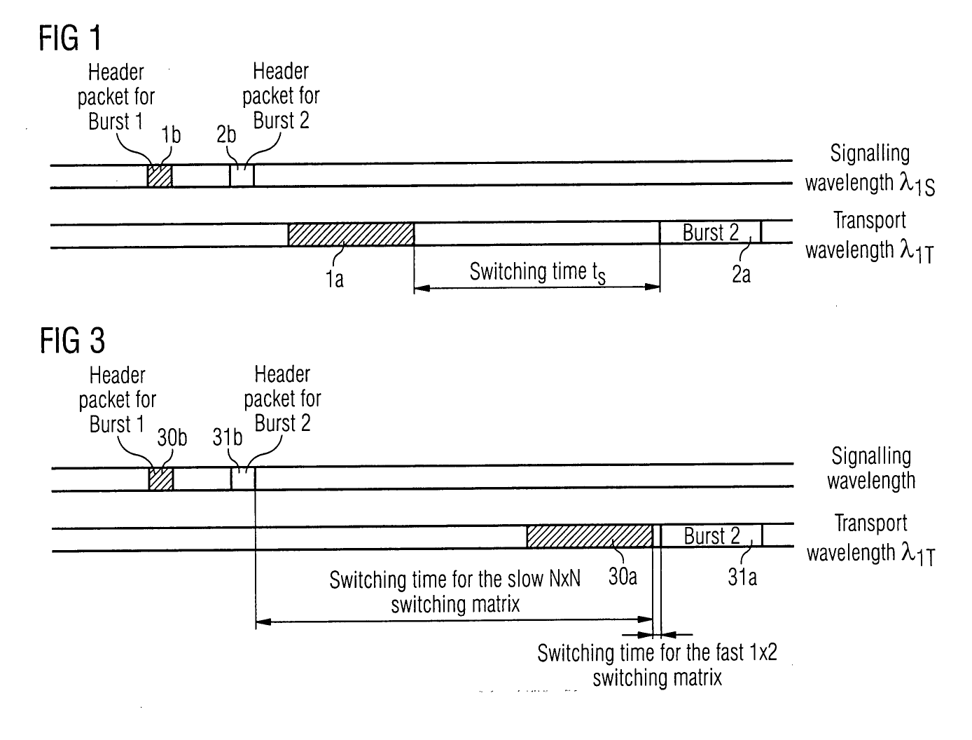

OBS networks that support high data rates require correspondingly high switching speeds at the network switches. Indeed, a switching time on the order of nanoseconds or even picoseconds is desirable in some networks. In an OBS network, the switching time introduces the constraint on the minimum time difference between the transmission across a switch of two consecutive bursts on a wavelength channel. This time constraint is illustrated in FIG. 1 which shows a first data burst la of transport wavelength λ_{1T} and its corresponding header packet burst 1b of signalling wavelength λ_{1S} travelling ahead of a second data burst 2a of transport wavelength λ_{1T} and its corresponding header packet burst 2b_{1S} of signalling wavelength λ_{1S}. If the switching time of a switch used to route the first 1a and second 1b data bursts is tₛ, then once the first data burst 1a has been switched by the switch, the second data burst 1b can be switched only after a time tₛ has elapsed. If the second data burst arrives at the switch before the switching time tₛ has elapsed, it is blocked. Such blocking occurs naturally in an optical switch for if an input port is not connected to an output port, the power of the optical signal it carries is simply lost. During the switching time, no information at the transport wavelengths corresponding to the input and output ports involved in the switching operation can be sent across the switch, so wavelength capacity is wasted. In some networks a relatively long switching time for a wavelength supporting a relatively low data rate ought not to be problematical. However, a switching time on the order of milliseconds for a wavelength supporting a data rate of Giga Bits per Second, would result in the lost opportunity of Mega Bits of information being switched during the switching time.

Known cheap switching fabrics such as Microelectromechanical Systems (MEMS) provide switching times on the order of milliseconds, which is not short enough for the data rate demands of OBS and APON networks that operate with link capacities on the order of Giga bits per second. Roughly speaking, the switching time for DWDM systems should be of the same order as the time between the transmission of two bits, or in other words, the inverse of the link capacity.

There are some types of switching fabrics that have switching times on the order of nano or even pico seconds which are short enough for OBS and APON networks. However, the current price of such fabrics is relatively expensive, being upwards of ten times or more expensive than a MEMS switching fabric. In addition, switching matrixes having more than two ports are made from cascading several switching elements, which leads to the problem of insertion loss in large switching matrixes.

In general then, a choice exists between relatively cheap switches that have long switching times resulting in inefficient bandwidth usage and increased blocking probability, and switches have a short switching time but which are relatively expensive.

Embodiments of the present invention aim to alleviate the above mentioned problems.

According to the present invention there is provided an optical switch for switching optical data bursts in a communications network, the switch comprising: a plurality of first optical switching matrixes each comprising a plurality of input ports and a plurality of output ports; a plurality of second optical switching matrixes each comprising at least one input port and a plurality of output ports and wherein each of the plurality of second optical switching matrixes has a different output port connected to a respective input port of each of the plurality of first optical switching matrixes; a plurality of optical combiners each comprising at least one output port and a plurality of input ports and wherein each of the plurality of optical combiners has a different input port connected to a respective output port of each of the plurality of first optical switching matrixes; and a controller for controlling the optical switch to switch optical data bursts from the input ports of the second optical switching matrixes to the output ports of the optical combiners across the plurality of first optical switching matrixes, the controller controlling the switch such that the plurality of first optical switching matrixes operate in parallel to switch optical data bursts across the switch.

The above and further features of the invention are set forth with particularity in the appended claims and together with advantages thereof will become clearer from consideration of the following detailed description of an exemplary embodiment of the invention given with reference to the accompanying drawings, in which:

FIG. 1 which has already been described illustrates data bursts and corresponding headers in an optical network;

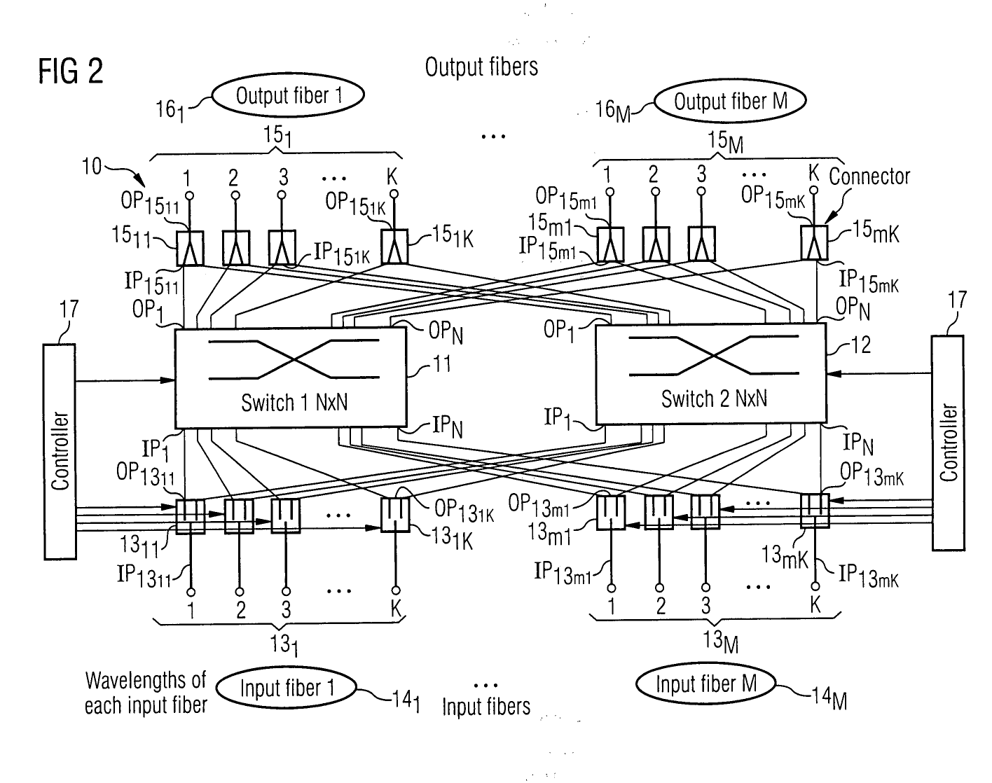

FIG. 2 illustrates an optical switch;

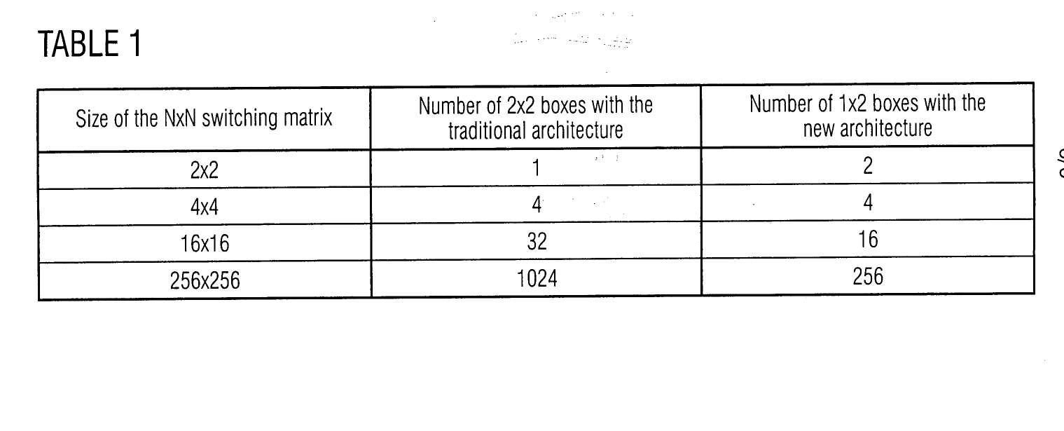

FIG. 3 illustrates data bursts and corresponding headers in an optical network.

Turning now to FIG. 2 of the accompanying drawings, an optical switch 10 comprises first 11 and second 12 low speed large switching matrixes. Each of the switching matrixes 11 and 12 comprises N input ports IP₁ to IP_{N} and N output ports OP₁ to OP_{N}. The switching matrixes 10 and 11 may thus be thought of as being N×N switches. Typically, the first 11 and second 12 switching matrixes have a switching speed of the order of milliseconds.

The switch 10 also comprises a plurality of sets of fast switching matrixes 13₁ to 13_{M}, of which the first set 13₁ and the M^{th} set 13_{M} are illustrated. Each of the M sets of fast switching matrixes comprises K fast switching matrixes, designated as 13ₘ₁ to 13_{mK}. Each of the fast switching matrixes 13ₘ₁ to 13_{mK} in a given set comprises a respective single input port which ports are designated as IP₁₃ₘ₁ to IP_{13mK}. Furthermore, each of the fast switching matrixes 13ₘ₁ to 13_{mK} comprises a respective pair of output ports, which pairs are designated as OP₁₃ₘ₁ to OP_{13mK}. Typically, each of the fast switching matrixes 13ₘ₁ to 13_{mK} within a given set has a switching speed on the order of nanoseconds or even picoseconds.

Each of the fast switching matrixes 13ₘ₁ to 13_{mK} within a given set has one of its output ports connected to a respective one of the input ports of the first low speed large switching matrix 11, and the other of its output ports connected to a respective one of the input ports of the second low speed large switching matrix 12.

The input ports of the fast switching matrixes 13ₘ₁ to 13_{mK} in any given set are connected to a respective one of a plurality of multi-mode input fibers designated 14₁ to 14_{M}. Each of the multi-mode input fibres 14₁ to 14_{M} supports K discrete wavelength modes λ₁ to λ_{K} or channels on which data bursts can be transmitted. Each of the input ports of the fast switching matrixes 13ₘ₁ to 13_{mK} in a given set is connected to receive data bursts having a particular one of the wavelengths λ₁ to λ_{K} supported by the multi-mode input fiber 14₁ to 14_{M} connected to that set.

On the output side, the optical switch 10 comprises a plurality of sets of optical combiners 15₁ to 15_{M}, of which the first set 15₁ and the M^{th} set 15_{M} are illustrated. Each of the M sets of optical combiners comprises K optical combiners, designated as 15ₘ₁ to 15_{mK}. Each of the optical combiners 15ₘ₁ to 15_{mK} in a given set comprises a respective pair of input ports, which pairs are designated as IP₁₅ₘ₁ to IP_{15mK} and a respective single output port, which ports are designated as OP₁₅ₘ₁ to OP_{15mK}.

Each of the optical combiners 15ₘ₁ to 15_{mK} in a given set has one of its input ports connected to a respective one of the output ports of the first low speed large switching matrix 11, and the other of its input ports connected to a respective one of the output ports of the second low speed large switching matrix 12.

The output ports of the optical combiners 15ₘ₁ to 15_{mK} in any given set are all connected to a respective one of a plurality of multi-mode output fibers designated 16₁ to 16_{M}. Each of the multi-mode input fibres 16₁ to 16_{M} supports K discrete wavelength modes λ₁ to λ_{K} or channels on which data bursts can be transmitted from the switch 10. Each of the output ports of the optical combiners 15ₘ₁ to 15_{mK} in any given set is for transmitting from the switch data bursts having a particular one of the wavelengths λ₁ to λ_{K} supported by the multi-mode output fiber 16₁ to 16_{M} connected to that set.

A control processor 17 processes information contained in header bursts to configure the slow switching matrixes 11 and 12 and the fast switching matrixes, to perform the switching of data bursts across the switch 10.

The architecture of the optical switch 10 takes advantage of the fact that in an OBS network a header burst packet always precedes a data burst in order to reserve bandwidth for the burst. Consequently, the optical switch knows in advance of a data burst actually arriving at the switch at what time the data burst is due. The structure of the first 11 and second 12 switching matrixes exploits this fact to switch data burst across the switch 10 in parallel.

During a switching operation, the switch 10 uses only one of the first 11 and second 12 switching matrixes to connect a pair of input and output fibers to switch a current data burst across the switch 10. When one of the first 11 and second 12 switching matrixes is active in transmitting a current data burst across the switch, if a header burst arrives to reserve bandwidth for a second subsequent data burst, the controller 17 begins to configure the currently non active of the first 11 and second 12 large switching matrixes to switch this subsequent data burst across the switch.

When the configuration of the currently non active large switching matrix is complete, the controller 17 configures the fast switching matrix having the input port at which the subsequent data burst is destined to arrive, so that its input port is connected to the currently non active large switching matrix. Thus when the second data burst arrives at the switch 10 it is switched across the switch via the currently non active large switching matrix.

Since the time between header and burst transmission (the so called offset time) is much bigger than the transmission time of a bit, the two large matrixes need not be comprised of an overly quick and hence expensive switching fabric. A switching fabric having a switching time on the order of milliseconds should be sufficient in most cases. The switching fabric used for the faster switches could be based on Holographic Switching technology or on Electro-absorption Modulator (EAM) technology. A key point is, that the above describes switch architecture, is cheaper than a switch architecture based on a fast N×N Holographic or EAM switch. This will be discussed in more detail below.

A specific example of the Switch 10 in operation will now be discussed with reference to FIG. 3. FIG. 3 illustrates a first data burst 30a of transport wavelength λ_{1T} and its corresponding header packet burst 30b of signalling wavelength λ_{1S} travelling ahead of a second data burst 31a of transport wavelength λ_{1T} and its corresponding header packet burst 31b of signalling wavelength λ_{1S}.

Assume that the first header packet burst 30b has previously arrived at the switch 10 which has processed the information contained in the header packet and is now in the process of transferring the first data burst 30 across the switch 10 from a given input port, say input port IP₁₃₂₁ connected to the input fiber 14₁, to a given output port, say output port OP₁₅₃₁ connected to the output fiber 16₁, via the first large switching matrix 11.

When the header packet 31b of the second data burst 31a arrives at the switch 10, the controller 17 processes the header packet to determine on which input port the second data burst 31a will arrive on and on which output port the second data burst will need to leave on. In this example assume that the second data burst 31a is to arrive on the same input port as the first data burst 30a, that is input port IP₁₃₂₁ connected to the input fiber 14₁, and is to leave on output port OP₁₅₃₁ connected to the output fiber 16₁.

The controller 17 configures the second switching matrix 12 to switch the second data burst 31a from the input port input port IP₁₃₂₁ to the output port OP₁₅₃₁. When the transmission of the first data burst 30a across the switch is completed, the fast switching matrix 13₁₂ connected to the input fiber 14₁ switches its output connection from the first switching matrix 11 to the second switching matrix 12.

Thus, when the second data burst 31a arrives at the switch 10 on the input fibre 14₁, it is transferred across the switch 10 via the second switching matrix 12, from the input port IP₁₃₂₁ of the fast switching matrix 13₁₂ to the output port OP₁₅₃₁ of the optical combiner 15₁₂.to exit the switch on output fiber 16₁.

Importantly, the switching time of the switch 10 is faster than the switching time of the individual fast switching matrixes. This can be understood by considering the following reasoning.

The basic actions performed by any switch when switching from an existing input port/output port through connection to a different input port/output port through connection are:

1) To process the control information that requests the initiation of the switching operation;

2) To check if there sufficient resources available to perform the desired switching operation;

3) To generate and coordinate the proper control messages needed to perform the switching operation;

4) To physically perform the switching operation.

Thus in the context of the above example, to switch the second data burst across the switch 10 via the second switching matrix 12, steps 1 to 3 may be performed in parallel with the transmission of the first data burst across the switch 10 via the first switching matrix 11. Therefore, it is only the time taken by step 4, i.e the time taken to physically perform the switching of the second data burst that defines the switching time of the whole switch.

For reasons of complexity, fast switching fabrics based on Holographic Switching or EAM can only be used in the manufacture of relatively small individual switching matrixes, for example, matrixes of dimension 2×2. Traditionally, to make larger switching matrixes, a plurality of small individual switching matrixes are cascaded together. Thus, for example, to produce a 16×16 switching matrix, thirty two 2×2 switching matrixes are cascaded together.

Table 1 illustrates the number of small switching matrixes required in order to make a N×N optical switch as N increase (column 1), for two different switch architectures, namely, the number of 2×2 switches in a traditional cascaded architecture (column 2); and the number of 1×2 switches in an architecture based on that of the switch 10.

The price of a traditional N×N switch may be defined as:
Price of traditional N×N switch=price of 2×2 switch×number of 2×2 cascaded switches.

The price of a new N×N switch constructed in accordance with the above described switch architecture may be defined as:
Price of new N×N switch=2×price N×N slow switch+(price of 1×2 switch+price of multiplexer)×number of 1×2 switches used.

A N×N slow switch is relatively cheap, for example, currently around 5,000 Euros for a MEMS switch, thus the price of a N×N switch constructed in accordance with the above described switch architecture is mainly determined by the price of the fast switching fabric 1×2 switch. Assuming that for a given fast switching fabric, the price of a 1×2 switch is the same as a 2×2 switch (in fact it is even cheaper) it can be understood from table 1 that the new switch architecture is cheaper than the state of the art architecture for switching matrixes larger than 4×4. Moreover the price difference between the two architectures increases almost linearly with the size of the matrix.

The invention may be used in other types of optical networks, for example, Adaptive Path Switched Optical Networks of the type described in our co-pending application DE 10339039.1.

Having thus described the present invention by reference to preferred embodiments it is to be well understood that the embodiments in question are exemplary only and that modifications and variations such as will occur to those possessed of appropriate knowledge and skills may be made without departure from the scope of the invention as set forth in the appended claims.

1. An optical switch for switching optical data bursts in a communications network, the switch comprising:
a plurality of first optical switching matrixes each comprising a plurality of input ports and a plurality of output ports;
a plurality of second optical switching matrixes each comprising at least one input port and a plurality of output ports and wherein each of the plurality of second optical switching matrixes has a different output port connected to a respective input port of each of the plurality of first optical switching matrixes;
a plurality of optical combiners each comprising at least one output port and a plurality of input ports and wherein each of the plurality of optical combiners has a different input port connected to a respective output port of each of the plurality of first optical switching matrixes; and
a controller for controlling the optical switch to switch optical data bursts from the input ports of the second optical switching matrixes to the output ports of the optical combiners across the plurality of first optical switching matrixes, the controller controlling the switch such that the plurality of first optical switching matrixes operate in parallel to switch optical data bursts across the switch.

2. A switch according to claim 1, wherein the controller controls the switch such that an optical data burst being switched across the switch is switched via a different one of the first optical switching matrixes than was an immediately preceding optical burst.

3. A switch according to any preceding claim wherein the second optical switching matrixes comprise a faster switching fabric than do the first optical switching matrixes.

4. A switch according to claim 4 wherein the second optical switching matrixes comprise an electro-absorption modulator based switching fabric or a holographic based switching fabric.

5. A switch according to claim 4 or claim 3 wherein the first optical switching matrixes comprise a micro electromechanical system based switching fabric.

6. A switch according to any preceding claim wherein the first optical switching matrixes are larger switching matrixes than are the second optical switching matrixes.
